(19) United States
(12) Patent Application Publication
(10) Pub. No.: US 2010/0104081 A1
(43) Pub. Date: Apr. 29, 2010

(54) SUBSCRIBER RATING SYSTEM

(75) Inventors: Ori Berman, Ramat-Hasharon (IL); Ronen David, Herzelia (IL); Roy Shilkrot, Negba (IL)

Correspondence Address: OHLANDT, GREELEY, RUGGIERO & PERLE, LLP, ONE LANDMARK SQUARE, 10TH FLOOR, STAMFORD, CT, 06901, US

(73) Assignee: Comverse, Ltd., Tel Aviv (IL)

(21) Appl. No.: 12/604,026

(22) Filed: Oct. 22, 2009

Related U.S. Application Data
(60) Provisional application No. 61/107,365, filed on Oct. 22, 2008.

(51) Int. Cl. H04M 3/42; G06Q 30/00

(52) U.S. Cl. 379/201.02; 705/14.43

(57) ABSTRACT

A method includes obtaining first information based on communication engaged in by a first subscriber via a communication service, calculating a first popularity rating of the first subscriber based on the first information, obtaining second information based on communication engaged in by a second subscriber via the communication service, calculating a second popularity rating of the second subscriber based on the second information, determining a ranking of the first subscriber based on comparing the first popularity rating and the second popularity rating, and providing a component service based on the ranking.

### CROSS-REFERENCE TO RELATED APPLICATIONS

This application claims the benefit of U.S. Provisional Application No. 61/107,365, filed Oct. 22, 2008. U.S. Provisional Application No. 61/107,365, filed Oct. 22, 2008 is hereby incorporated by reference in its entirety.

### BACKGROUND OF THE INVENTION

1. Field of the Invention

The present disclosure relates generally to a communication engaged in by a subscriber via a communication service. More particularly, the present disclosure relates to calculating a popularity rating and popularity ranking based on a communication engaged in by a subscriber via a communication service.

2. Description of Related Art

Subscribers engage in communication via a communication service, for example, a telephony network service. Generally, service providers of the communication service do not compare information concerning one subscriber's communications via the communication service with information concerning communication engaged in by other subscribers of the communication service. Absent such a comparison, all subscribers to the communication service are treated and viewed similarly by service providers within a group of subscribers of the communication service.

Accordingly, there is a need for a system and method to compare information concerning subscribers' communications via a communication service. There is a further need for a system and a method to calculate a popularity ranking of a subscriber of a communication service.

### BRIEF SUMMARY OF THE INVENTION

There is provided a method that includes obtaining first information based on a communication engaged in by a first subscriber via a communication service, calculating a first popularity rating of the first subscriber based on the first information, obtaining second information based on a communication engaged in by a second subscriber via the communication service, calculating a second popularity rating of the second subscriber based on the second information, determining a ranking of the first subscriber based on comparing the first popularity rating and the second popularity rating, and providing a component service based on the ranking. There is also provided a system that performs the method, and a storage medium that contains instructions for controlling a processor to perform the method.

The above-described and other advantages and features of the present disclosure will be appreciated and understood by those skilled in the art from the following detailed description, drawings, and appended claims.

### BRIEF DESCRIPTION OF THE DRAWINGS

FIG. 1 is a call flow diagram of a communication in a telephony system that includes a subscriber rating system.

FIG. 2 is a data structure of a quantity of communications.

FIG. 3A is a graphical depiction of popularity ratings of a first group of subscribers to a subscriber rating system.

FIG. 3B is a graphical depiction of popularity ratings of a second group of subscribers to a subscriber rating system.

FIG. 3C is a graphical depiction of popularity ratings of a third group of subscribers to a subscriber rating system.

FIG. 4 is a block diagram of a first telephony system having a subscriber rating system according to the present disclosure.

FIG. 5 is a block diagram of a second telephony system having a subscriber rating system according to the present disclosure.

FIG. 6 is a block diagram of a third telephony system having a subscriber rating system according to the present disclosure.

FIG. 7 is a block diagram of a fourth telephony network having a subscriber rating system according to the present disclosure.

FIG. 8 is a block flow diagram of a method of a subscriber rating system.

FIG. 9 is a block diagram of a subscriber rating system.

### DETAILED DESCRIPTION OF THE INVENTION

The present description introduces a concept referred to herein as a “popularity rating.” A popularity rating is a calculation of information based on a communication engaged in by a subscriber via a communication service provided by a service provider.

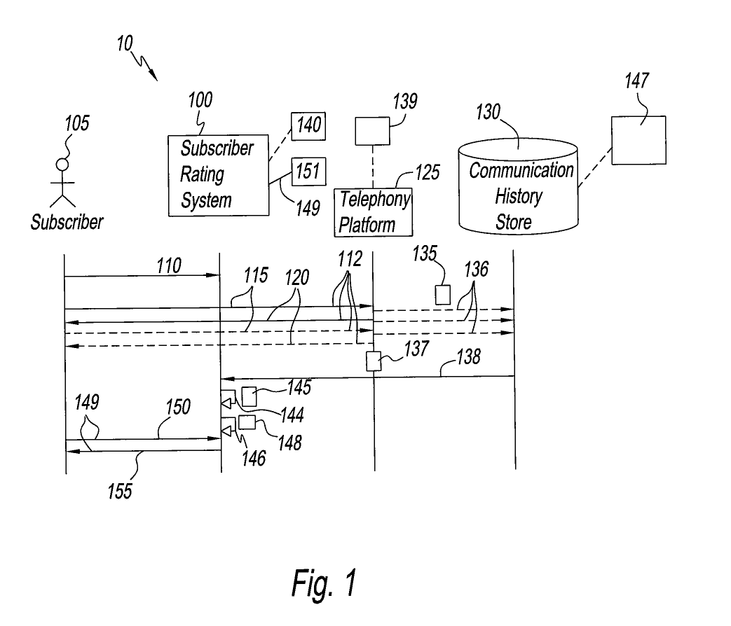

FIG. 1 is a call flow diagram of a communication in a telephony system 10 that includes a subscriber rating system 100. FIG. 1 shows a subscriber 105 that registers with subscriber rating system 100 in registering or registering step 110. Subscriber 105 registers 110 with subscriber rating system 100 by communicating with the subscriber rating system, for example, by an Internet web page, telephone call, text message, e-mail, and analogous contacts, to input and receive information relating to use of the subscriber rating system.

Subscriber 105 engages in one or more communications in an engaging or engaging step 112. Subscriber 105 places communications to telephony platform 125 of a service provider in a placing or placing step 115 and receives communications from telephony platform 125 in a receiving or receiving step 120. Subscriber 105 engages 112 in communications, for example, calls, short message service (SMS) messages, multi-media service (MMS) messages, emails, application and/or Internet downloads, via a subscriber device, for example, a mobile phone. Communication information 135 concerning subscriber 105 is communicated 136 from telephony platform 125 to a database 130.

Database information 137 is communicated 138 from database 130 to subscriber rating system 100. Database information 137 is information based on communications engaged in by subscriber 105. Database information 137 may include measurements of breadth of communication, for example, a length of calls engaged in by subscriber 105, and a number of calls and/or a number of SMS messages engaged in by subscriber 105. Database information 137 may include measurements of patterns of communication, for example, a time of day when calls are engaged in by subscriber 105, and a time of engaging in calls by subscriber 105 to a specific contact. Database information 137 may include any combination of information described herein.

Subscriber 105 may communicate with a contact 139. Database information 137 may include an amount of use of the communication service by contact 139, a number of times subscriber 105 communicates with contact 139, an identification of contact 139, a popularity rating of contact 139, an identification of additional subscribers in which contact 139 communicates, and any combination thereof. Contact 139 may also be a subscriber of subscriber rating system 100. The information relating to contact 139 can establish subscribers that maintain higher intercommunication with each other.

Database information 137 can be communicated to subscriber rating system 100 from external measurements that come from sources 140 outside database 130. For example, external ranking information can be added by tracking public social networks activity of subscribers.

Subscriber rating system 100 calculates, in a calculation or calculation step 144, a popularity rating 145 for subscriber 105 based on database information 137 communicated by database 130. The database information 137 and calculation 144 of popularity rating 145 may be established initially, for example, by the service provider. Database information 137 and calculation 144 of popularity rating 145 by subscriber rating system 100 may be adjusted or changed after initially establishing calculation 144 and database information 137 of popularity rating 145, for example, by the service provider.

Popularity ratings may be calculated by subscriber rating system 100 for more than one subscriber. Subscriber rating system 100 obtains additional information 147 concerning communications engaged in by additional subscribers, and subscriber rating system 100 calculates popularity ratings of the additional subscribers based on additional information 147.

Subscriber rating system 100 determines, in a determination or determination step 146, a popularity ranking 148 for subscriber 105 by comparing popularity rating 145 of subscriber 105 to popularity ratings of additional subscribers. The popularity rankings of the remaining additional subscribers may also be determined by comparing each popularity rating to the other subscribers' popularity ratings. The popularity ratings may be ranked based upon a predetermined criteria. The predetermined criteria may be established initially, for example, by the service provider. The predetermined criteria may be adjusted or changed after initially establishing the predetermined criteria, for example, by the service provider. For example, the service provider identifies a number of calls made by subscribers as the predetermined criteria. Subscriber rating system 100 determines the popularity ranking of the popularity ratings based on number of calls made by subscribers. For example, subscriber rating system 100 will rank the popularity ratings from a popularity rating that reflects a highest number of calls made by a subscriber to a popularity rating that reflects a lowest number of calls made by a subscriber. Another example of the predetermined criteria includes the service provider identifying a number of calls made of those contacted by the subscriber as the predetermined criteria.

For example, calculation 144 of popularity rating 145 of subscriber 105 may be based on quantity of communication, quality of communication, versatility of contacts, popularity of contacts with whom subscriber 105 engages in communication, or any combinations thereof. Combinations of database information 137 may be used. Subscriber rating system 100 may assign each database information 137 in a combination, a weight that increases or decreases impact of each of database information 137 in calculation 144 of popularity rating 145.

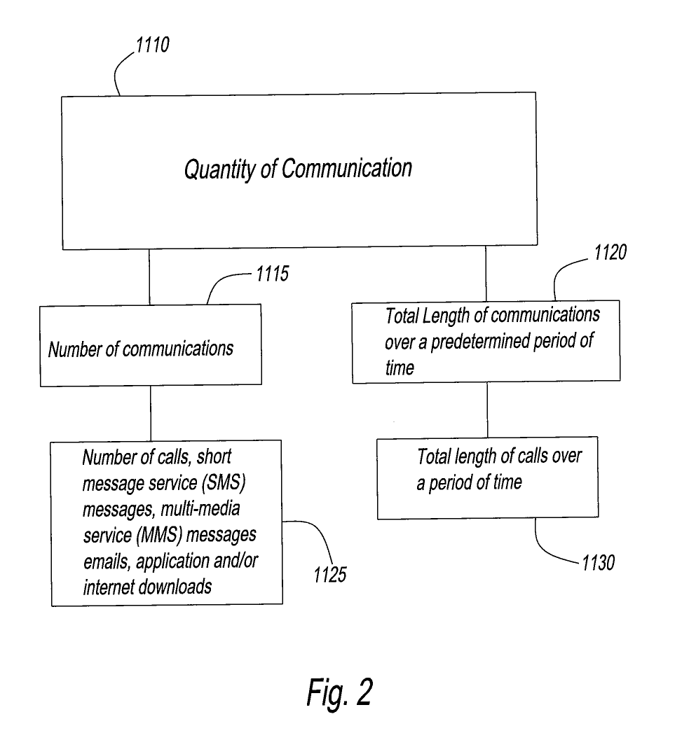

FIG. 2 is a data structure 1100 of a quantity of communications 1110. Quantity of communications 1110 by subscriber 105 includes a number of communications 1115 engaged in by subscriber 105; total length of communications over a predetermined period of time 1120 of subscriber 105; number of calls, short message service (SMS) messages, multi-media service (MMS) messages, emails, application and/or Internet downloads 1125; total length of calls over a period of time 1130, or any combinations thereof. Incoming communication that subscriber 105 receives 120 and outgoing communication that subscriber places 120 may be assigned different weights, so that incoming communications have a greater impact on popularity rating 145 or popularity rank 148 than outgoing communications. For example, subscriber A may have made 20 calls and received 20 calls in one month and subscriber B may have made 20 calls and received 10 calls in one month. In this example, a subscriber receives one (1) point for each call made and two (2) points for each call received and the points are totaled to equal a popularity rating. In this example, the popularity rating of subscriber A equals 60 and the popularity rating of subscriber B equals 40, as calculated by subscriber rating system 100. Accordingly, in this example, subscriber rating system 100 ranks subscriber A number 1 and subscriber B number 2 so that subscriber A ranks higher than subscriber B.

Quality of communication is a measurement that may vary between a component service of communication service. Calculation 144 based on quality of communication determines a standard for which a communication is measured against. For example, when calculating popularity rating 145 based on a duration of a phone conversation, a standard of a threshold duration can be defined, such that all conversations shorter than the threshold duration will not be considered “rankable” or included in calculation 144 of popularity rating 145.

Versatility of contacts is a measurement of the number of active contacts of a subscriber. For example, a subscriber that is talking ten times with ten different people has a popularity rating that ranks higher or is more popular than a subscriber talking twenty times with five different people.

Below are several examples of calculations of popularity ratings and popularity rankings. These examples are not exhaustive and are not limiting.

For example, subscriber A may have made 20 calls in one month and subscriber B may have made 15 calls in one month. In this example, a subscriber receives a point for each call and the points are totaled to equal a popularity rating. The popularity rating of subscriber A equals 20 and the popularity rating of subscriber B equals 15, as calculated by subscriber rating system 100. In this example, a service provider prefers subscribers making more calls than other subscribers who make less calls. Accordingly, subscriber rating system 100 ranks subscriber A number 1 and subscriber B number 2 so that subscriber A ranks higher than subscriber B that makes less calls than subscriber A.

Another example includes subscriber A who has made 20 calls in one month totaling a length of 100 minutes of communication and subscriber B has made 15 calls in one month totaling 200 minutes of communication. In this example, the service provider prefers subscribers engaging in communication over longer periods of time than other subscribers engaging in communication over shorter periods of time. Accordingly, in this example, subscriber rating system 100 calculates popularity rating by assigning a point for each call made as well as a point for each minute of communication in which a subscriber engages and summing all points assigned. The popularity rating of subscriber A equals 120 and the popularity rating of subscriber B equals 215, as calculated by subscriber rating system 100. Subscriber rating system 100 ranks subscriber A number 2 and subscriber B number 1 so that subscriber B ranks higher than subscriber A.

In addition, subscriber rating system 100 may calculate popularity ratings based upon popularity ratings of subscribers contacted by other subscribers. For example, subscriber rating system 100 calculates 144 popularity rating 145 of subscriber 105 based on a popularity rating for each subscriber with whom subscriber 105 communicates. Alternatively, subscriber rating system 100 may rank the popularity ratings of subscribers based on the popularity ratings of subscribers contacted. Where subscriber rating system 100 calculates 144 popularity rating 145 based upon popularity ratings of the subscribers that are contacted, a social effect is created. For example, subscriber 105 would like to engage in communication with a subscriber having a higher or more popular popularity rating or popularity ranking in order to enhance the subscriber 105's own popularity rating or popularity ranking. For example, subscriber A has a popularity rating that includes 100 popularity points and wishes to be ranked higher. Subscriber B is already very popular with a popularity rating that includes 1000 popularity points. In this example, subscriber rating system 100 includes a sum of points in calculating the popularity rating, and ranks the popularity ratings from a popularity rating reflecting a highest sum of points to a popularity rating reflecting a lowest number of points. Also in this example, additional points are assigned to subscribers based upon contact with subscribers having a high or popular popularity rating. Subscriber A will try to befriend subscriber B, by calling or sending messages to subscriber B, to strengthen the social bond between them. In this example, subscriber A's rank will increase, as calculated by subscriber rating system 100, based on a strong relationship with the popular subscriber B.

A further example includes where a service provider offers an unpopular or new component service that has an undesirable amount of usage by subscribers, or low usage. Subscriber rating system 100 may increase an impact of usage of the new or unpopular component service in the calculation 144 of popularity rating 145 or determination 146 of popularity ranking 148. Subscribers are motivated or provided with incentive to increase their usage of the unpopular component service in order to increase their own popularity rating and popularity ranking, and make the new or unpopular component service more appealing to subscribers. For example, MMS messaging penetration is determined not sufficient and SMS messaging is determined sufficient by the service provider. In this example, subscriber rating system 100 includes a sum of points in calculating the popularity rating, and ranks the popularity ratings from a popularity rating reflecting a highest sum of points to a popularity rating reflecting a lowest number of points. Also in this example, the service provider may define that each outgoing MMS message contributes 200 points to calculation 144 of popularity rating 145, whereas each outgoing SMS message contributes only 10 points to calculation 144 of popularity rating 145.

Another example of calculating a popularity rating and a popularity ranking includes Subscriber A who is listed in a web-based social networking and blogging service that enables users to send communications displayed on a web page and delivered, for example, via SMS message, to other followers, e.g., Twitter service. In this example, Subscriber A has 1000 followers, which is considered a high number. Subscriber A is considered, in objective terms, a popular person in some circles. Further in this example Subscriber A is not a very communicative person in telecommunication terms, i.e., does not make or receive many phone calls or other services via the communication service offered by the service provider. In this example, the popularity ranking of Subscriber A is low or unpopular, based on the combination of Subscriber A's use of the web-based social networking and blogging service and communications via the communication service of the service provider, even though subscriber A has relatively high use of the web-based social networking and blogging service. The service provider can offer Subscriber A a bundle of services, with boosted popularity ranking accumulation so that use by Subscriber A of the bundle of service will increase Subscriber A's popularity ranking. This will encourage Subscriber A to increase communication over the service provider's infrastructure, rather than the infrastructure of the web-based social networking and blogging service, so the provider gains a popular and communicative person in its subscriber base.

Each time subscriber 105 engages 112 in communication, subscriber rating system 100 may receive information data 137 from database 130. Each time subscriber rating system 100 receives information data 137 from database 130, subscriber rating system 100 may recalculate an updated popularity rating and determine an updated popularity ranking of subscriber 105.

Subscriber rating system 100 provides, in a providing or providing step 149, a component service based upon the popularity rating, popularity ranking, or any combination thereof. Subscriber rating system 100 may provide 149 a component service based upon the popularity rating, popularity ranking, or any combination thereof, to subscriber 105 or to another subscriber or third party 151. For example, subscriber 105 sends, in a sending or sending step 150, a communication to subscriber rating system 100 requesting information. Subscriber rating system 100 provides a component service 149 by communicating, in a communicating or communicating step 155, information, for example, popularity rating, popularity ranking, or any combination thereof, to subscriber 105 upon receiving the request. Subscriber 105 may send 150 the request by a device used for placing 115 communications to telephony platform 125 and receiving 120 communications. Alternatively, subscriber 105 may send the request from a different device, for example, a phone or personal computer.

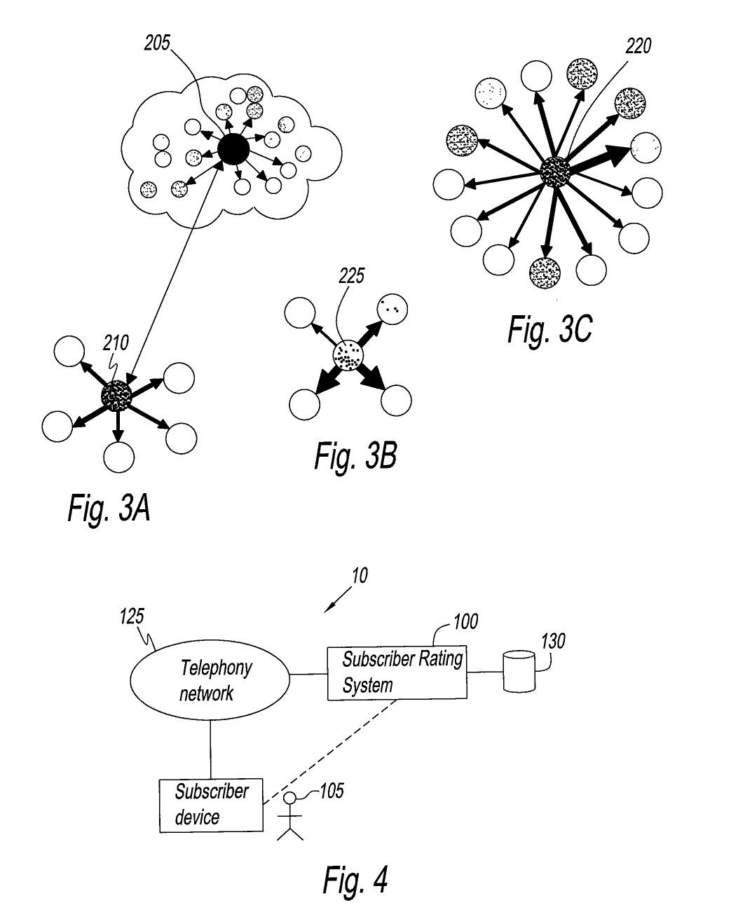

FIGS. 3A-C are graphical depictions of popularity of subscribers of subscriber rating system 100. The subscribers are shown as circles each with a shading according to their popularity ranking. The darker the shading of subscribers, the more popular or higher ranking. Communication between subscribers is shown by arrows. The larger the arrow, the higher communication flow is between subscribers connected to the arrow. In FIG. 3A, subscriber 205 communicates on a regular basis with many subscribers, therefore, in this example, subscriber 205 is a very popular user with a high popularity ranking. Subscriber 210 speaks regularly with a small amount of subscribers, but subscriber 210 speaks with subscriber 205, so, in this example, subscriber 210 is popular by approximation. In FIG. 3B, subscriber 225 speaks heavily with a small amount of people, therefore, in this example, subscriber 225 has a low popularity ranking. In FIG. 3C, subscriber 220 communicates regularly with a fair amount of subscribers, therefore, in this example, subscriber 220 has an average popularity ranking.

FIGS. 4-7 are block diagrams of different configurations of a telephony system 10 having subscriber rating system 100 included therein. FIG. 4 shows subscriber rating system 100 communicating with telephony platform 125 and database 130, and telephony platform 125 communicates with subscriber rating system 100 and subscriber 105 via a subscriber device, such as a mobile phone. Subscriber 105 engages 112 in communication with telephony platform 125. Telephony platform 125 communicates communication information 135 to subscriber rating system 100. Subscriber rating system 100 communicates communication information 135 to database 130. Database 130 communicates database information 137 to subscriber rating system 100. Subscriber rating system 100 calculates 144 popularity rating 145, determines 146 popularity ranking 148, and provides 149 a component service based on popularity rating 145 and/or popularity ranking 148. Subscriber 105 and subscriber rating system 100 may also communicate. The configuration of system 100 shown in FIG. 4 lessens a load on a switching system of telephony platform 125, than if telephony platform 125 communicated database information 137 to subscriber rating system 100. Telephony platform 125 of FIG. 4 may send reports to subscriber rating system 100 and database 130 on slow hours or free times of telephony platform 125.

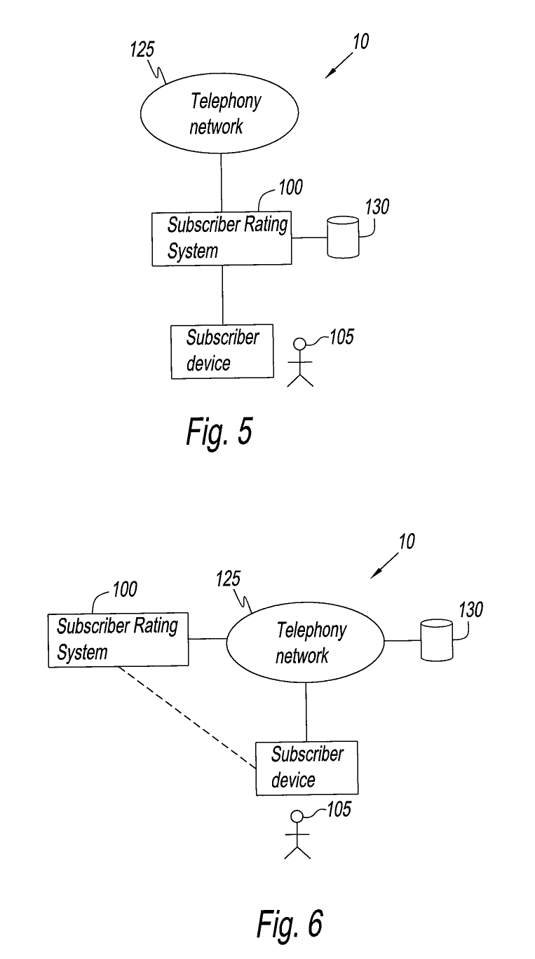

FIG. 5 includes subscriber 105 that engages 112 in communication that is communicated to subscriber rating system 100 via a subscriber device providing subscriber rating system 100 with communication data 135. Subscriber rating system 100 communicates communication data 135 to database 130 and communicates the communication subscriber 105 engages 112 in to telephony platform 125. Database 130 communicates database information 137 to subscriber rating system 100. Subscriber rating system 100 calculates 144 popularity rating 145, determines 146 popularity ranking 148, and provides 149 a component service based on popularity rating 145 and/or popularity ranking 148. In the configuration of FIG. 5, subscriber 105 reports communications to subscriber rating system 100, eliminating a need for telephony platform 125 to do so. The configuration of FIG. 5 may be limited by information network availability and require subscriber and/or service provider installation on devices which can be costly and require labor.

FIG. 6 includes subscriber 105 that engages 112 in communication with telephony platform 125 via a subscriber device. Telephony platform 125 communicates communication information 135 to database 130. Database 130 communicates database information 137 to telephony platform 125. Telephony platform 125 communicates database information 137 to subscriber rating system 100. Subscriber rating system 100 calculates 144 popularity rating 145, determines 146 popularity ranking 148, and provides 149 a component service based on popularity rating 145 and/or popularity ranking 148. Subscriber 105 and subscriber rating system 100 may also communicate. In the configuration of FIG. 6, faster information transfer rates may be achieved. Telephony platform 125 communicates communication information 135 to database 130 and bypasses subscriber rating system 100 to eliminate a need to transfer all communication information 135 to database 130 by subscriber rating system 100 and can lessen a load on servers of subscriber rating system 100.

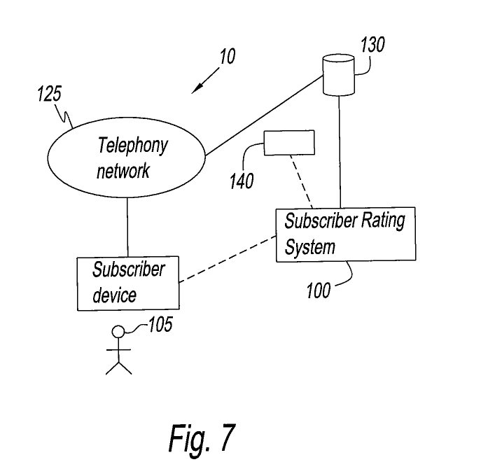

FIG. 7 includes subscriber 105 that may also communicate with subscriber rating system 100. FIG. 7 is the configuration of the call flow diagram of FIG. 1.

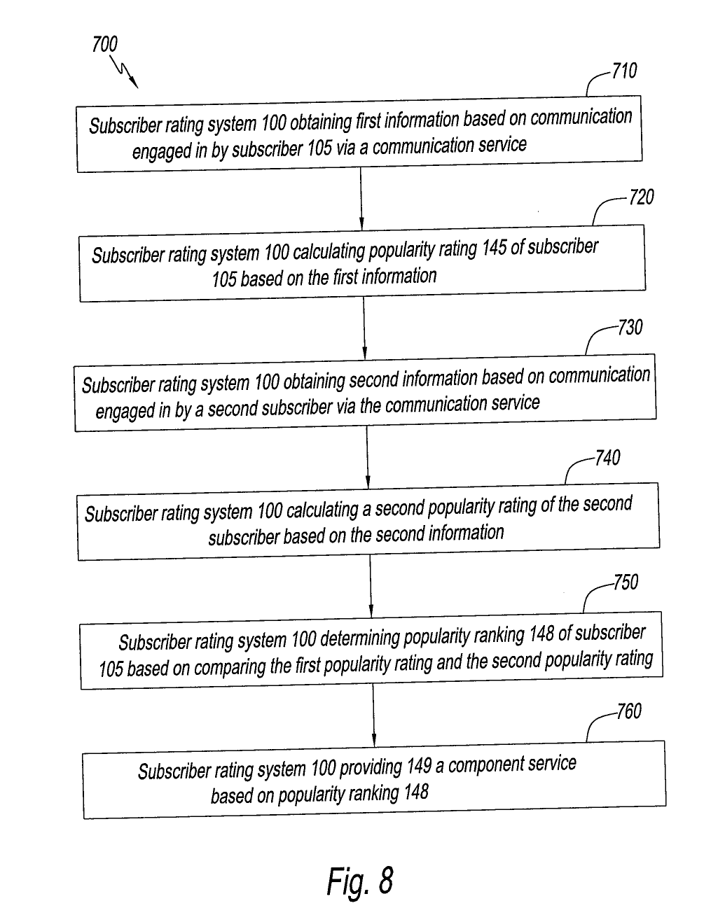

FIG. 8 is a block flow diagram of a method 700 of subscriber rating system 100. In step 710, subscriber rating system 100 obtains first information based on a communication engaged in by subscriber 105 via a communication service. The first information may be obtained from database 130. In step 720, subscriber rating system 100 calculates popularity rating 145 of subscriber 105 based on the first information. The calculation of popularity rating 145 by subscriber rating system 100 may include different information and/or different combinations of information. In step 730, subscriber rating system 100 obtains second information based on a communication engaged in by a second subscriber via the communication service. In step 740, subscriber rating system 100 calculates a second popularity rating of the second subscriber based on the second information. In step 750, subscriber rating system 100 determines popularity ranking 148 of subscriber 105 based on comparing the first popularity rating and the second popularity rating. In step 760, subscriber rating system 100 provides 149 a component service based on popularity ranking 148.

Below are several examples of providing 149 a component service based on popularity rating or popularity ranking. These examples are not exhaustive and are not limiting.

Subscriber rating system 100 may provide 149 a component service of issuing a communication to a device generating a message notifying subscriber 105 of popularity ranking 148. The message may be a SMS message or email message. Subscriber rating system 100 may send updated rankings to subscriber 105 at predetermined points in time or intervals, for example, weekly or after each time the popularity rating or popularity ranking is updated.

Another example includes the service provider notifying subscriber 105 and other subscribers of a popularity contest conducted over a predetermined time period. The highest or most desirable popularity ranking of subscriber 105 and the other subscribers determined by subscriber rating system 100 at the end of the time period is determined the winner of the popularity contest. Subscriber rating system 100 may provide 149 a component service to a device, for example, a phone, accessible by the subscriber who is determined the winner, to issue a communication generating the message notifying the subscriber of the winning popularity ranking. A device, for example, phones accessible by each of the subscribers who are not determined the winner, may be issued the communication generating a message notifying the subscribers of the losing popularity ranking.

Subscriber rating system 100 may provide 149 a component service of issuing a communication to a device having an address book that positions subscriber 105 in the address book based on popularity ranking 148. Popularity ranking 148 determined for subscriber 105 may be communicated to devices, for example, phones, of other subscribers each having an address book including information relating to subscriber 105 as well as information relating to other subscribers each having a popularity ranking. The device or subscriber rating system 100 may sort the information according to the popularity rankings of the subscribers and subscriber 105. This component service can ease an address book scanning process by serving the highest likely people the user would like to contact at a given time.

Subscriber rating system 100 may provide 149 a component service of performing a search for subscriber information based on a query, and issuing a communication to a device identifying information of the subscriber based on the popularity ranking. For example, one subscriber of subscriber rating system 100 may communicate a query to subscriber rating system 100 requesting subscriber information. The request may include hints or keywords. Subscriber rating system 100 searches popularity rankings or communication information 135, including those of subscriber 105, to determine if subscriber 105 is the most likely subscriber that would be requested by the one subscriber based on the popularity ranking or popularity rating.

Subscriber rating system 100 may provide 149 a component service of issuing a communication to a device of a subscriber that generates a message to alert the subscriber of an event in a pattern of information used to calculate the popularity rating. For example, subscriber rating system 100 may determine a calling pattern of communication information 135 or database information 137, and issue a communication to a device, for example, a phone, accessible by subscriber 105 generating a message suggesting likely times and contacts for subscriber 105. A further example, includes subscriber 105 that may communicate with his mother every day at 5:00 PM. Subscriber rating system 100 may detect this pattern in communication information 135 or database information 137. Subscriber rating system 100 may then issue a communication at 5:00 PM each day to subscriber 105's phone generating a message to call subscriber 105's mother without subscriber 105 having to set an alarm on the phone.

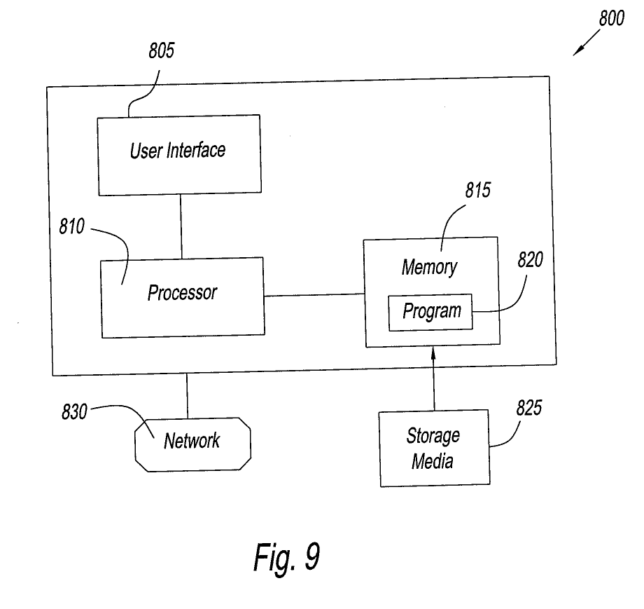

FIG. 9 is a block diagram of a subscriber rating system 100, for employment of the present disclosure. Subscriber rating system 100 includes a computer 800 coupled to a network 830, e.g., the Internet.

Computer 800 includes a user interface 805, a processor 810, and a memory 815. Although computer 800 is represented herein as a standalone device, it is not limited to such, but instead can be coupled to other devices (not shown) via network 830.

Processor 810 is configured of logic circuitry that responds to and executes instructions.

Memory 815 stores data and instructions for controlling the operation of processor 810. Memory 815 may be implemented in a random access memory (RAM), a hard drive, a read only memory (ROM), or a combination thereof. One component of memory 815 is a program module 820.

Program module 820 contains instructions for controlling processor 810 to execute the methods described herein. For example, as a result of execution of program module 820, processor 810 obtains first information based on a communication engaged in by subscriber 105 via a communication service, calculates popularity rating 145 of subscriber 105 based on the first information, obtains second information based on a communication engaged in by a second subscriber via the communication service, calculates a second popularity rating of the second subscriber based on the second information, determines popularity ranking 148 based on comparing the first popularity rating and the second popularity rating, and provides a component service based on the popularity ranking 148. The term “module” is used herein to denote a functional operation that may be embodied either as a stand-alone component or as an integrated configuration of a plurality of sub-ordinate components. Thus, program module 820 may be implemented as a single module or as a plurality of modules that operate in cooperation with one another. Moreover, although program module 820 is described herein as being installed in memory 815, and therefore being implemented in software, it could be implemented in any of hardware (e.g., electronic circuitry), firmware, software, or a combination thereof.

User interface 805 includes an input device, such as a keyboard or speech recognition subsystem, for enabling a user to communicate information and command selections to processor 810. User interface 805 also includes an output device such as a display or a printer. A cursor control such as a mouse, track-ball, or joy stick, allows the user to manipulate a cursor on the display for communicating additional information and command selections to processor 810. User interface 805 may be provided so that the service provider may adjust or change the formula or database information 137 to calculate popularity rating.

Subscriber 105 may communicate with subscriber rating system 100 over network 830 via web-service, SMS messages, MMS messages, mobile Internet and interactive voice response. The subscriber can communicate with subscriber rating system 100 over network 830 to create new contests, invite their friends to join contests, join contests, access popularity ranking and contest history, and manage a profile of the subscriber. Contests can include contests based on popularity ranking. For example, subscriber 105 accesses a website to view the popularity rating. The website may be accessed via phone or personal computer. Interactive voice response may also provide access to subscriber rating system 100 to subscriber 105.

The service provider may communicate with subscriber rating system 100 over network 830 via web application to set and change calculation 146 that determines popularity ranking 148 calculated by subscriber rating system 100; set and change calculation 144 of popularity rating 145 calculated by subscriber rating system 100; and managing contests, for example, opening and closing contests. The service provider may set promotions and prizes to contest winners via the interface to subscriber rating system 100. The service provider may manage advertisement campaigns via an interface over network 830 of subscriber rating system 100.

Processor 810 outputs, to user interface 805, a result of an execution of the methods described herein. Alternatively, processor 810 could direct the output to a remote device (not shown) via network 830.

While program module 820 is indicated as already loaded into memory 815, it may be configured on a storage medium 825 for subsequent loading into memory 815. Storage medium 825 can be any conventional storage medium that stores program module 820 thereon in tangible form. Examples of storage medium 825 include a floppy disk, a compact disk, a magnetic tape, a read only memory, an optical storage media, universal serial bus (USB) flash drive, a digital versatile disc, or a zip drive. Alternatively, storage medium 825 can be a random access memory, or other type of electronic storage, located on a remote storage system and coupled to computer 800 via network 830.

It should also be noted that the terms “first”, “second”, “third”, “upper”, “lower”, and the like may be used herein to modify various elements. These modifiers do not imply a spatial, sequential, or hierarchical order to the modified elements unless specifically stated.

While the present disclosure has been described with reference to one or more exemplary embodiments, it will be understood by those skilled in the art that various changes may be made and equivalents may be substituted for elements thereof without departing from the scope of the present disclosure. In addition, many modifications may be made to adapt a particular situation or material to the teachings of the disclosure without departing from the scope thereof. Therefore, it is intended that the present disclosure not be limited to the particular embodiment(s) disclosed as the best mode contemplated, but that the disclosure will include all embodiments falling within the scope of the appended claims.

What is claimed is:

1. A method comprising:
obtaining first information based on communication engaged in by a first subscriber via a communication service;
calculating a first popularity rating of said first subscriber based on said first information;
obtaining second information based on communication engaged in by a second subscriber via said communication service;
calculating a second popularity rating of said second subscriber based on said second information;
determining a ranking of said first subscriber based on comparing said first popularity rating and said second popularity rating; and
providing a component service based on said ranking.

2. The method of claim 1, wherein said first information is obtained at a first time, and further comprising:
obtaining updated information of said first information at a second time,
updating said first popularity rating with said updated information, and
determining an updated ranking of said first subscriber based on comparing said first popularity rating with said updated information and said second popularity rating.

3. The method of claim 1, wherein said first information is selected from the group consisting of (a) a length of communications engaged in by said first subscriber, (b) a time of engaging in said communications by said first subscriber, (c) a number of said communications engaged in by said first subscriber, (d) a time of engaging in said communications to a contact by said first subscriber, and (e) any combinations thereof.

4. The method of claim 1,
wherein said first subscriber uses said communication service to communicate with a contact, and
wherein said first information is selected from the group consisting of (a) an amount of use of said communication service by said contact, (b) a number of times said first subscriber communicates with said contact, (c) identification of said contact, (d) a popularity rating of said contact, (e) identification of additional subscribers in which said contact communicates, and (f) any combinations thereof.

5. The method of claim 1, wherein said providing said component service comprises providing a component service of said communication service to said first subscriber based on said ranking.

6. The method of claim 1, wherein said providing said component service comprises issuing a communication to a device having an address book that positions said first subscriber in said address book based on said ranking.

7. The method of claim 1, wherein said providing said component service comprises performing a search for subscriber information based on a query and issuing a communication to a device identifying information of said first subscriber based on said ranking.

8. The method of claim 1, further comprising issuing a communication to a device of said first subscriber that generates a message to alert said first subscriber of an event in a pattern of said first information.

9. The method of claim 1, wherein said providing said service comprises issuing a communication to a device generating a message notifying said first subscriber of said ranking.

10. The method of claim 1, further comprising adjusting said determining of said ranking of said first subscriber.

11. The method of claim 1, wherein calculating said first popularity rating of said first subscriber based on said first information that is based on information selected from the group consisting of (a) quantity of communication by said first subscriber, (b) quality of communication of said first subscriber, (c) versatility of contacts of said first subscriber, (d) popularity of said contacts of said first subscriber, (e) and any combinations thereof.

12. The method of claim 1, wherein said providing said service comprises issuing a communication to a device generating a message notifying said first subscriber of said ranking in intervals via a communication selected from the group consisting of short messaging service message or email service.

13. The method of claim 1, further comprising accessing said ranking by said first subscriber via medias selected from the group consisting of (a) a web-service, (b) short messaging service message, (c) multi-media messaging service message, (d) mobile internet, and (d) interactive voice response.

14. The method of claim 1, further comprising accessing said ranking by said first subscriber by a user interface to conduct an activity selected from the group consisting of (a) creating a contest, (b) inviting a contact to join a contest, (c) accessing said ranking, (d) accessing contest history, and (d) managing a profile of said first subscriber.

15. The method of claim 1, further comprising accessing said ranking by a service provider of said communication service by a user interface to conduct an activity selected from the group consisting of (a) setting and changing a formula that determines said ranking, (b) managing a contest, (c) setting promotions, and (d) managing advertisements.

16. A system comprising:
a processor; and
a memory that contains instructions that control said processor to cause said processor to perform actions of:
obtaining first information based on communication engaged in by a first subscriber via a communication service;
calculating a first popularity rating of said first subscriber based on said first information;
obtaining second information based on communication engaged in by a second subscriber via said communication service;
calculating a second popularity rating of said second subscriber based on said second information;
determining a ranking of said first subscriber based on comparing said first popularity rating and said second popularity rating; and
providing a component service based on said ranking.

17. The system of claim 16, wherein said first information is obtained at a first time, and
wherein said actions further comprise:
obtaining updated information of said first information at a second time,
updating said first popularity rating with said updated information, and
determining an updated ranking of said first subscriber based on comparing said first popularity rating with said updated information and said second popularity rating.

18. The system of claim 16, wherein calculating said first popularity rating of said first subscriber based on said first information is based on a group is selected from the group consisting of (a) quantity of communication by said first subscriber, (b) quality of communication of said first subscriber, (c) versatility of contacts of said first subscriber, (d) popularity of said contacts of said first subscriber, (e) and any combinations thereof.

19. A storage medium comprising instructions tangibly embodied thereon, wherein said instructions are readable by a processor, and cause said processor to perform actions of:
obtaining first information based on communication engaged in by a first subscriber via a communication service;
calculating a first popularity rating of said first subscriber based on said first information;
obtaining second information based on communication engaged in by a second subscriber via said communication service;
calculating a second popularity rating of said second subscriber based on said second information;
determining a ranking of said first subscriber based on comparing said first popularity rating and said second popularity rating; and
providing a component service based on said ranking.

20. The storage medium of claim 19, wherein said first information is obtained at a first time, and
wherein said actions further comprise:
obtaining updated information of said first information at a second time,
updating said first popularity rating with said updated information, and
determining an updated ranking of said first subscriber based on comparing said first popularity rating with said updated information and said second popularity rating.

21. The storage medium of claim 19, wherein calculating said first popularity rating of said first subscriber based on said first information is based on a group is selected from the group consisting of (a) quantity of communication by said first subscriber, (b) quality of communication of said first subscriber, (c) versatility of contacts of said first subscriber, (d) popularity of said contacts of said first subscriber, (e) and any combinations thereof.
